(19) United States
(12) Patent Application Publication
(10) Pub. No.: US 2005/0256749 A1
(43) Pub. Date: Nov. 17, 2005

(54) Product inventory management system

(75) Inventors: Shane Robert Crockett, Shenton Park (AU); Stephen Lawrence Wells, Sorrento (AU); Clare Elizabeth Power, Subiaco (AU)

Correspondence Address: BIRCH STEWART KOLASCH & BIRCH, PO BOX 747, FALLS CHURCH, VA, 22040-0747, US

(73) Assignee: EVIIVO LIMITED, London (GB)

(21) Appl. No.: 10/507,926

(22) PCT Filed: Mar. 20, 2003
(86) PCT No.: PCT/AU03/00340

§ 371 Date: Apr. 15, 2005

(51) Int. Cl. G06F 17/60

(52) U.S. Cl. 705/5

(57) ABSTRACT

A system to facilitate bookings including at least one business centre, each business centre having at least one product available for booking, wherein each business centre includes a first processing means for receiving and making bookings of at least one product from at least one agent or customer, and a central data centre including a second processing means for receiving and making bookings of at least one product from at least one agent or customer or at least one other agent or customer; wherein at one or more predetermined periods or actions one first and second processing means are synchronised so that booking information in the first and second processing means is the same.

### FIELD OF THE INVENTION

The present invention is directed towards a booking system, and in particular an improved system for managing and marketing within the tourism industry.

### BACKGROUND OF THE INVENTION

Generally, providers of tourism products require a network in order to market and distribute their product. This product may take the form of accommodation, available tours, or other such activities. The majority of current networks are based on inefficient manual systems involving the older paradigms of wholesalers, retailers and loose industry associations. Most such networks are relatively cumbersome and ineffective as most consumers are now seeking to view and purchase these products in online environments. There is an overwhelming need to create a system that allows these businesses to participate in this environment but to do so on an individual and independent basis. The underlying problem is that fragmented businesses do not have the capacity to use the effectiveness of aggregated purchasing and selling.

The various problems associated with this industry are yet to be addressed, and businesses continue to rely on manual systems of telephone, facsimile, and allocated inventories. Commonly, a person wishing to book a holiday may approach their travel agent with various enquiries. For example the customer may wish to stay in a particular region on a specified date. In order to accommodate the customers request, the travel agent is required to phone various hotels within the specified region to ascertain their availability and costs. The various availabilities and costings may then be referred back to the customer to make a selection. The travel agent is then required to again contact the selected hotel so as to confirm booking. In many cases, this may mean that the travel agent is required to spend considerable time trying to ascertain the availability of various hotels within a region. It is also likely that a travel agent will become familiar with or prefer a certain hotel or chain of hotels. This could result in the customer staying at a hotel which is not optimum to their requirements.

It is also possible that many smaller hotels or other establishments offering accommodation may not be known to the travel agent and therefore not contacted. Further such small establishments may not be able to afford the advertising necessary to raise awareness of their establishments.

As the demand for making bookings via the web has increased, many businesses have adopted a web based inventory allotment system so as to cater for these needs. In this arrangement a certain number of rooms are allocated to the web based system for general distribution, and have generally been unsuccessful from the individual businesses point of view. The system does require the business to allocate a set number of rooms or inventory to the web system. Should enquiries be made directly to the business they will be unable to offer these web based allocations. This could mean that the business may have to decline a customer even when web based inventory has not been sold. Further, if the rooms or inventory are allotted to the web based system are not sold the business would not be able to sell that product. A business could run the risk of selling the web based allotment to direct customers but could result in double booking of customers.

Another system has been the adoption of intermediary sellers. Such systems have been developed that require specific points of sale to make enquiries to a central database which has manually entered business products onto it. These systems have also proved cumbersome, as the businesses do not have direct real-time access to the data on the central database. In addition, the systems have generally been developed on a customised basis. That is they are purpose built for one information centre or outlet and may not be compatible with other developed systems. Accordingly, such systems are not ideal for a travel agent.

There is therefore a need for a system which enables ready access to various businesses, and also for the efficient booking of inventory provided by these businesses.

### OBJECT OF THE INVENTION

It is therefore an object of this invention to provide a system which enables booking to be made by a plurality of agents to a plurality of business institutions in an efficient and relatively simple matter.

### SUMMARY OF THE INVENTION

With the above object in mind, the present invention provides a system to facilitate bookings including:
at least one business centre, each said at least one business centre having at least one product available for booking, wherein each said at least one business centre includes a first processing means for receiving and making bookings of said at least one product from at least one agent or customer; and
a central data centre including a second processing means for receiving and making bookings of said at least one product from said at least one agent or customer or at least one other agent or customer;
wherein at one or more predetermined periods or actions said first and second processing means are synchronised so that booking information in said first and second processing means is the same.

It is envisaged that the synchronisation will take place during or after each booking, although in a preferred embodiment, additional and/or manual synchronisation will be possible.

In one embodiment, the business centre may be an establishment offering accommodation, and the product may be rooms available at that establishment. Alternatively, the business centre could be a tour operator and the products various tours and trips available through that tour operator.

In another aspect the present invention provides a business centre booking system including a first processing means to receive and make bookings of at least one product available from said business centre; a communication means to receive bookings made via an external server of said at least one product; wherein at a predetermined time said first processing means synchronises data with said external server via said communication means.

In a further aspect the present invention provides a synchronised booking system including a second processing means for receiving and making bookings of at least one product available from at least one business centre; a communication means to enable said bookings to be synchronised with a first processing means of said at least one business centre.

The communication means can be any available means which enables the first and second processing means to communicate and may be made via a global computer network.

### BRIEF DESCRIPTION OF THE DRAWINGS

FIG. 1 exemplifies a basic arrangement of the preferred embodiment of the present invention.

FIG. 2 shows a preferred arrangement for interaction between the client and the system.

FIG. 3 shows a preferred arrangement for managing and updating data in the system.

FIG. 4 exemplifies the synchronisation process of the preferred embodiment of the present invention.

### DESCRIPTION OF PREFERRED EMBODIMENT

The present invention seeks to allow a business to operate independently whilst simultaneously offering compatibility with a multitude of selling and buying operations which may be critical to the businesses success. The system is relevant to all categories of the tourism industry in order that efficiencies for the individual businesses by aggregating their buying and selling power in those areas were there is no competitive advantage can be obtained. The present description will be limited to the example of hotel or room accommodation. However, it will be appreciated that other areas will equally fall within the scope of the present invention. For example, various operators offering tours and day trips may equally benefit from this invention.

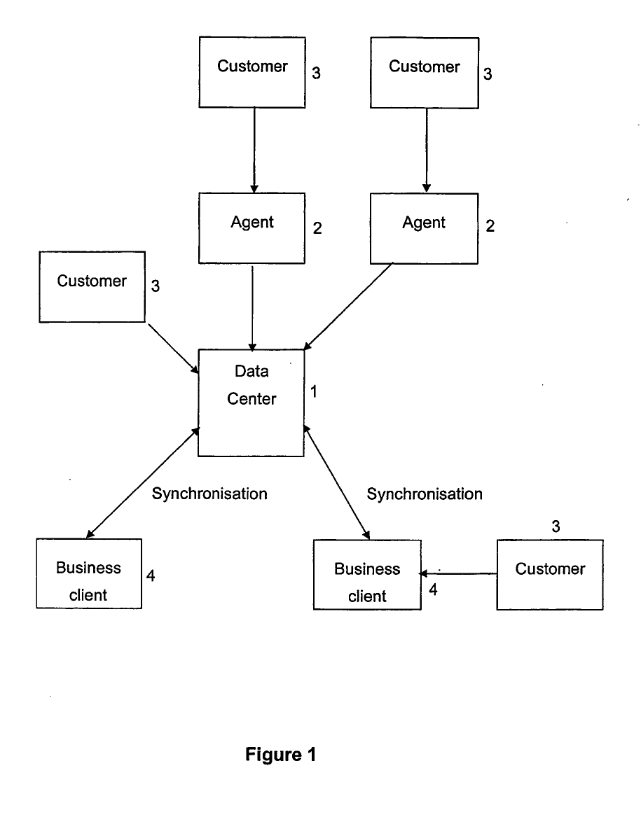

FIG. 1 shows the basic arrangement of the preferred embodiment of the present invention. The system will include a data centre 1 which houses a central processor which is able to hold data of each business client 4. It is envisaged that any number of business clients 4 may be linked to the system. Each business client 4 has a processing unit which includes a resident application which enables the business to operate the system. This resident application enables each business client 4 to receive and make booking from customers 3.

The customer 3 may contact the business client 4 directly to ascertain whether any products are available for booking. For example, the business client 4 may be a hotel, and the customer 3 desires to book a room at that hotel. The hotel or business client 4 will review the resident application to ascertain whether any room or product is available. On the assumption that a room is available, and the customer 3 proceeds with the booking, the resident application of the business client 4 will be updated to show that the room has been booked.

A similar system to the resident application is present in the data centre 1. In this way, a customer 3 may connect to the data centre 1 to book a product or room with the business client 4. Again assuming that the customer proceeds with the booking, the processing unit of the data centre 1 will indicate that the desired room is no longer available. Alternatively, a customer 3 may approach an agent 2 who has access to the data centre 1. The agent 2 on behalf of the customer 3 can review and make bookings with the data centre 1. In many cases, it may appear to the agent 2 (or customer 3), that they are making a booking directly with the business client 4 rather than through an intermediary centre such as the data centre 1. Again, assuming that the agent 2 confirms a booking on behalf of the customer 3, the processing unit of the data centre 1 indicates that the room or product is booked and no longer available for any other customer.

At predetermined intervals, for example at the completion of each booking, the data centre 1 and respective business client 4 synchronise their data with each other. That is, the processing unit of the data centre 1 is adjusted to reflect any bookings made directly to the business client 4. Similarly, the resident application of the business client 4 is also updated to reflect any bookings made via the data centre 1. In this way, the data centre 1 and business client 4 both have an up to date record of bookings made with the business client 4, and thereby details of the products which may still be available for booking.

It will be appreciated that as the data stored in both the data centre 1 and business client 4 are continuously synchronised, that the data centre 1 also effectively provides a back-up of the business centres 4 data. Accordingly, if the business centre 4 was to experience some technical problem which caused loss of their data, the business centre 4 need only synchronise with the data centre 1 to restore their systems. Whilst not a primary concern in designing the present system, it will be appreciated that this source of back-up data is highly advantageous to each business client 4.

The present system has solved a major problem by creating a system that can operate as a resident application of the business computer network and at the same time have a real-time synchronisation capacity with any point of distribution whether it is to a consumer direct or via an agent. The synchronisation and relationship database capacity may be utilised to deliver a multitude of business critical operations to the business.

In the preferred embodiment, a travel application may be downloaded or otherwise installed on a host system for a business. The application can then form the central point of the package acting as the interface to all the services of the system. In this way, all applications are fully integrated and the system is the entry point into each members business.

Accordingly, the application should be simple and built to meet the primary needs of the user group. Ideally, the user will be able to customise specific aspects of the application to suite their particular model. Ideally the installable application will allow tourism operators of varying types to maintain their bookings and give them access to all the applications of the system and also provide access to all services provided by the system.

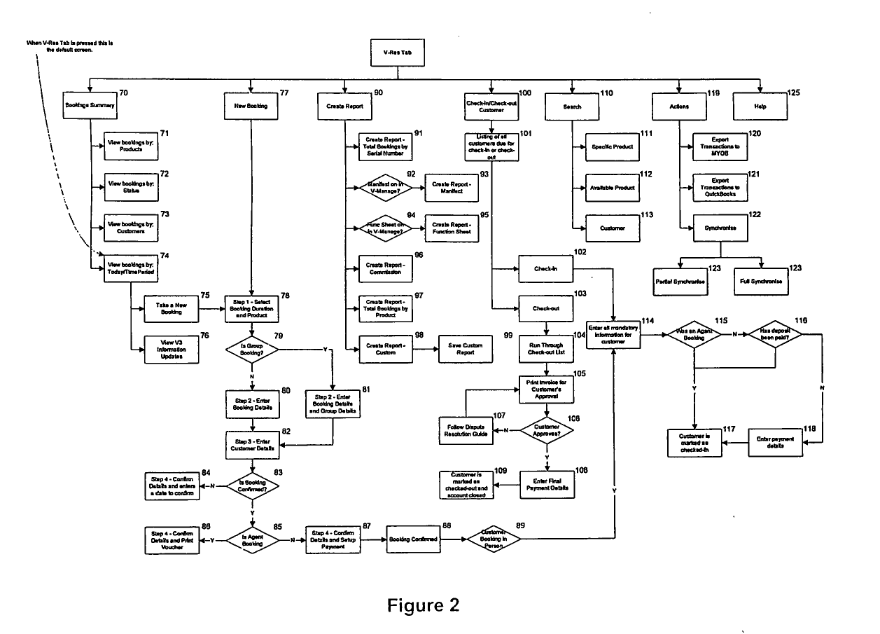

Referring to FIG. 2, the operation of the main interface that will be provided to operators in the preferred embodiment can be seen. This main interface can be used in a day to day operation of the application. For simplicity, the system may be implemented such that this main interface is the same or substantially the same on both the resident application of the business client 4, and on the central processing unit in the data centre 1. By causing both data centre 1 and business client 4 to have the same interface, assistance may be easier to provide, modifications and changes easier to make, and synchronisation of data easier to achieve.

The operator may be provided with a number of options including a summary of bookings 70, making a new booking 77, creating a report 90, checking customers in and out 100, searching 110, other actions 119, or accessing online help 125. Depending on the application, the user may be able to obtain booking summaries 70, by viewing the bookings by product 71 for example by room types, or alternatively by status 72 for example available rooms. The operator may also be able to view bookings by customers 73 or alternatively bookings within a predefined time period 74. For example the system could be configured to default to the current date. The operator may be able to access information updates 76 which could include details of the products. For ease of use, the operator should be able to take a new booking 75 from the booking summary 70, rather than requiring the operator to return to the main screen to initiate a new booking 77.

Once a new booking 75, 77 is selected, the operator will be requested to enter details such as the product required, and the duration of the booking. The operator may then be asked to enter various booking details 80 and also customer details 82. Depending on the embodiment, the system may be configured to perform a synchronisation check at this time to ensure that the product or room is available. It will then be necessary to confirm the booking 83, and as necessary confirm the various details 84. Depending on the application, if an agent is booking the product 85, then the system may simply confirm the details and print a voucher 86. Alternatively, if an agent is not booking 85 the product the system may prompt for payment details 87.

The system can be customised to provide other processes which the business client will usually carry out. For example the system can assist in checking in 102 a customer and prompting the operator to enter the requested information 114. Similarly, in checking out 103 a customer the operator can run through a required checklist 104 and follow various procedures until the customer is marked as checked out and the account closed 109.

Whilst the system should be configured to automatically synchronise at predefined periods or actions, for example following a confirmed booking, the business client 4 may also elect to synchronise 122 the data. This could take the form of a partial synchronisation 123 or a full synchronisation 124. It is envisaged that the partial synchronisation 123 may only include booking details, booking details for a specific product or any other predefined parameters. Whereas, it is envisaged that full synchronisation 124 will include a synchronisation of all data stored in the system, including customer address details product descriptions, prices, and bookings.

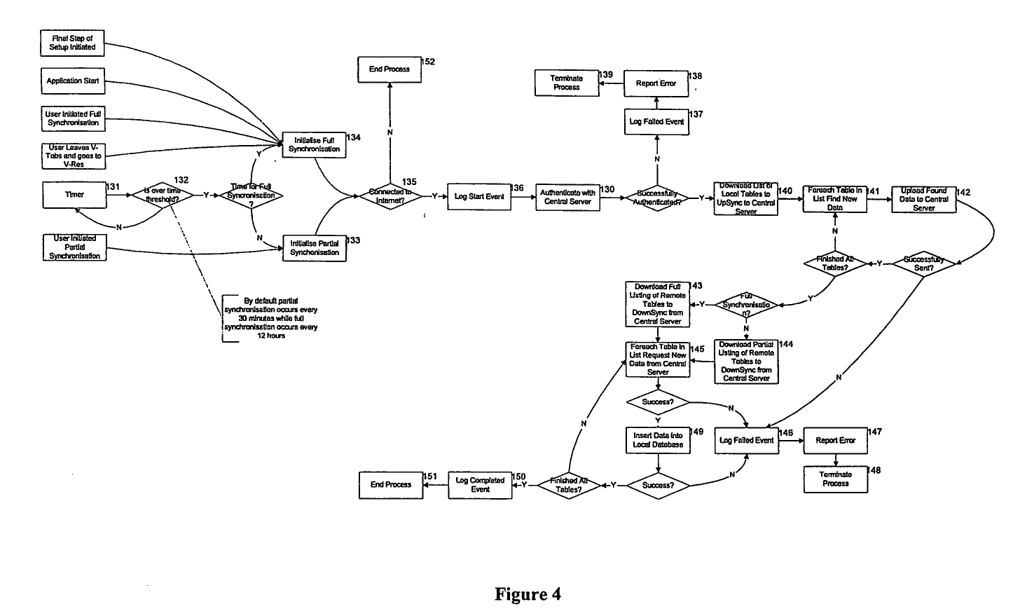

Referring to FIG. 4, a possible synchronisation process is exemplified. The central server 130 can be housed in the data centre 1 and stores the details of the business client 4, and any bookings made by an agent 2 or customer 3. Once synchronisation is initiated by timer 131 and if the time threshold has been passed 132 a partial 133 or full 134 synchronisation is initiated depending on last time of synchronisation. If not connected to the Internet 135 the process ends 152. If connected to the Internet 135 an event is logged 136 stating the start of a synchronisation process. Authentication 130 occurs between the resident application and the central server. If this fails an event is logged 137, the error is reported 138 and the process terminates 139. A table listing of local tables 140 to upsync is retrieved from the central server. For every table found in the listing find all local data that has changed since last synchronisation 141. Upload this data to the central server 142.

If the synchronisation is a full synchronisation a full listing of remote tables is requested from the central server 143. Otherwise a partial listing of remote tables is requested from the central server 144. For every table found in the listing request data from the central server 145. If this fails an event is logged 146, the error is reported 147 and the process terminates 148. Insert requested data into the resident application 149. If this fails an event is logged 146, the error is reported 147 and the process terminates 148.

Log an event 150 stating the process has completed successfully and then end the process 151.

In this manner, bookings made either by the data centre 1 or business client are continually updated and data integrity maintained.

As part of the installation process, the system may include a user friendly registration process so as to gather all necessary information to automate as many functions as possible for the business. For example, this may include access to direct-debt, and automated Internet connections. Ideally, each business client 4 will be able to manage all settings that relate to their business. This can include things like managing products, their descriptions and also relevant price schedules. It can also be used to manage login and user information for users of the application and allow the operator to create a website which plugs into the standard template driven site.

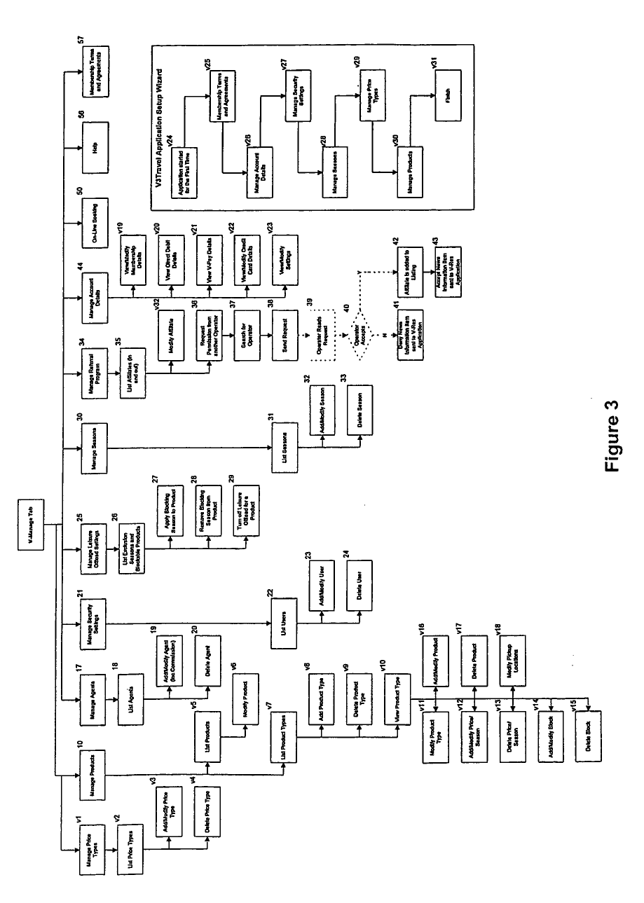

In the preferred embodiment, these manage functions are exemplified in FIG. 3. Assuming that a new business client 4 downloads or installs the resident application on their system, then on initial start up the system should determine whether the application is being started for the first time 58. If it is not the first time then the system will proceed to the normal or home page of the business clients 4 system. Assuming that the system has been commenced for the first time, then the system should request that the business client 4 enter or manage their account details 59. This may include managing their products 10, their agents 17, or any other account details. Once the account details 59 have been entered, the system should prompt the business client 4 to manage their security settings 60. This can be achieved by prompting the business client 4 to manage their security settings 21. Once the security settings have been managed 60, the business client 4 may then be prompted to customise the settings 61 of their system. This may include managing any offloads 25, entering seasonal information 30, managing an affiliate list 34, entering account details 44, creating website information 50 or any other information that may be desired depending on the embodiment.

In managing their products 10, the business client 4 is provided with a summary list of existing products v5, obviously if it is the first time entering the system this list will not contain any entries. The business client 4 will be able to view all product types v7, again this will be empty if it is the first time entering. The business client 4 will be able to add a product type v8 for example a deluxe suite to group several products. Once a product type has been added the business client has the ability to add or modify price/seasons v12 to it. This defines a price at a time of the year for any associated products. At this stage an individual product can be added to the product type v16. By adding a product v16, the business client 4 is effectively adding a product which may be booked either directly or via the data centre 1. The business client 4 may also be able to modify product types v11. For example a deluxe suite may be modified into an exquisite suite. Similarly, the business client 4 will be able to modify a product v16. This could enable the business client 4 to maintain the relevance of the database at all times. For example, it is possible that following an upgrade a hotel may have upgraded a number of standard rooms to superior rooms.

Ideally, the business client 4 should be able to set and manage individual security settings 21. This may be achieved by listing the various users 22, adding or modifying users 23, or deleting users 24. In this way, the business client 4 can ensure that only authorised persons have access to various aspects of the system to thereby avoid mismanagement of the system. For example, an operator or booking clerk may be given access to make bookings but not to alter pricings.

In the preferred arrangement, when the business client 4 makes any modifications, the modifications will be made to the processing unit housed in the data centre 1. Once these modifications are completed, the data centre 1 will initiate synchronisation with the business client 4 to thereby update the resident application. Whilst it would be possible to update the resident application and synchronise the central processing unit in the data centre 1, the former arrangement is preferred so as to reduce the possibility of bookings being made whilst the data is being updated. For example, if a business client 4 was updating the resident application it is possible that the data centre 1 could be taking bookings, on for example rooms that are to be renovated, by updating the data centre 1, it would not be possible for any agents 2 or customers 3, to make bookings via the data centre 1, and presumably, the business client 4 would be aware that modifications are being made.

Whilst the system should guard against double bookings, the system will preferably include an integrated dispute resolution system which will alert an operator to any double bookings. It is presumed that preference will be given to any online bookings. In this way should a business attempt to book a room which has already been allocated, the system should alert the user to this fact.

It is envisage that a central database will be utilised to which all clients can establish connections to synchronise data. This centralised database may also be the link between the clients software and credit card transactions through the system thereby allowing online transactions to be processed and transferred directly into the business nominated account. The database structure should be such as to facilitate online bookings, keep track of customer data, allow the operator to access industry specific resources, and allow the system to manage the process. The database may be accessed by a public website. This website may act to market the system and also provide access to the various businesses. Ideally, any necessary user manuals or product support may be downloadable from this site. Accordingly, it is envisaged that the website will provide an easily accessible portal to both businesses using the system, and for customers or agents wishing to book with businesses linked to the system.

In some embodiments, it may be possible for businesses to offer specials or reduced cost packages. These specials may be relayed to the central database for distribution or for ready access by any other agent or customer. This system could alternatively be automated, such that if a particular room has not been booked, then the cost for that room will decrease as a date draws near. For example, if no bookings have been made for a particular room within one month, then a fifteen percent reduction may be offered. Further reductions may be automatically offered each week leading up to the actual date so as to entice web users to place a booking.

In use, a travel agent or customer may connect directly to the system. The system will enable the agent to view the various businesses, and the availability of any rooms together with their costing's. As this data is synchronised with the centralised database, the agent may be confident that the information is up to date, and that the rooms marked as available are in fact available. The agent or user may then place a booking which may be confirmed by payment via a credit card, so as to guarantee that room. The system would then be updated so that any other agent or customer accessing the system would be able to see that the room was no longer available.

The system may be configured such that in confirming a booking, the agent provides credit card details for payment. The system may either accept this payment directly and then reimburse each business, or may enable the credit card payment to be directly credited towards a business nominated account. A receipt and/or confirmation number may be provided to the agent or customer.

The present invention is dramatically different from any previous attempt as it captures the advantages of both a resident application and a web based distribution system by having real-time synchronisation capacity linked to a multitude of business functionality.

Whilst the method and system of the present invention has been summarised and explained by illustrative examples, it will be appreciated by those skilled in the art that many widely varying embodiments and applications are within the teaching and scope of the present invention, and that the examples presented herein are by way of illustration only and should not be construed as limiting the scope of this invention.

1. A system to facilitate bookings including:
at least one business centre, each said at least one business centre having at least one product available for booking, wherein each said at least one business centre includes a first processing means for receiving and making bookings of said at least one product from at least one agent or customer; and
a central data centre including a second processing means for receiving and making bookings of said at least one product from said at least one agent or customer or at least one other agent of customer;
wherein at one or more predetermined periods of actions said first and second processing means are synchronized so that booking information in said first and second processing means is the same.

2. A system as claimed in claim 1 wherein synchronisation occurs after each booking.

3. A system as claimed in claim 1 or claim 2 wherein an operator can initiate synchronisation.

4. A system as claimed in claim 1 wherein said business centre offers accommodation.

5. A system as claimed in claim 4 wherein said product included rooms available at said business centre.

6. A system as claimed in claim 1 wherein said business centre is a tour operator.

7. A system as claimed in claim 6 wherein said product includes tours available from said tour operator.

8. A system as claimed in claim 1 wherein said synchronization includes:
first and second processing means identifying any values that have changed since a previous synchronization; and
said first processing means forwarding any said changed values to said second processing means, and said second processing means forwarding any said changed values to said first processing means.

9. A system as claimed in claim 1 further including a dispute resolution system to alert a user to possible double bookings.

10. A system as claimed in claim 1 wherein said first and second processing means both include a common user interface.

11. A system as claimed in claim 1 wherein modifications to booking conditions are made to said second processing means and then synchronized to said first processing means.

12. A business centre booking system including:
a first processing means to receive and make bookings of at least one product available from said business centre;
a communication means to receive bookings made via an external server of said at least one product;
wherein at a predetermined time said first processing means synchronises data with said external server via said communication means.

13. A synchronized booking system including:
a second processing means for receiving and making bookings of at least one product available from at least one business centre;
a communication means to enable said bookings to be synchronised with a first processing means of said at least one business centre.

14. A system substantially as hereinbefore described with reference to the accompanying figures.
